(19) United States
(12) Patent Application Publication
(10) Pub. No.: US 2008/0123563 A1
(43) Pub. Date: May 29, 2008

(54) Conference Voice Station And Conference System

(76) Inventors: Rolf Meyer, Wennigsen (DE); Axel Haupt, Langenhagen (DE); Karl-Hermann Dellbruegge, Hannover (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 11/666,590

(22) PCT Filed: Oct. 28, 2005
(86) PCT No.: PCT/EP05/11539

§ 371 Date: Oct. 11, 2007

(30) Foreign Application Priority Data
Oct. 28, 2004 (DE) 10 2004052487.4

(51) Int. Cl. H04L 12/18

(52) U.S. Cl. 370/260

(57) ABSTRACT

A conference voice station for a conference system has an audio unit for converting audio signals into network-specific signals, a network interface for transmitting the network-specific signals to an external network and for receiving network-specific signals from an external network, and a network identification unit for storing a network identification.

### CROSS-REFERENCE TO RELATED APPLICATIONS

This application claims priority of International Application No. PCT/EP2005/011539, filed Oct. 28, 2005 and German Application No. 10 2004 052 487.4, filed Oct. 28, 2004, the complete disclosures of which are hereby incorporated by reference.

### FIELD OF THE INVENTION

The present invention is directed to a conference voice station for a conference system.

### DESCRIPTION OF THE RELATED ART

Conference systems such as the SDC 8000 conference system by Sennheiser or the MCW-D-200 wireless conference system by Beyerdynamic which can be operated with or without wires are known. Delegate units (or voice stations), a chairman voice station and possibly interpreter voice stations are interconnected by an independent, special proprietary bus system. Voice stations of this kind typically have a microphone, a loudspeaker and a plurality of operator controls, e.g., an operator control for channel selection, a vote button, a button for turning the microphone on and off, and a slot for a chip card. The chip cards are used for personalizing the voice station. Further, the voice station has an interface for the bus system of the conference system. The voice station is usually embodied in a housing so that the microphone and/or loudspeaker and the interface of the voice station are arranged in the same housing. In this way, the voice stations can be personalized and encrypted.

Further, some conference systems offer the possibility of connecting a portable computer in particular to the conference system. In this way, data transmission is carried out between these computers, but over a separate network in the conference system and not over the special bus system of the voice stations.

Further, hard-wired methods for transmitting digital audio data such as AES-EBU and SPDIF formats for single-channel stereo transmission and the ADAT (8-channel) and MADI (64-channel) formats for multichannel transmission methods are known. These methods are point-to-point connections, i.e., the audio data are exchanged between two stations: a transmitting station and a receiving station.

Heretofore, analog systems with more than two stations and with the possibility of transmitting a plurality of channels at the same time were based on the frequency multiplexing method where each channel is assigned a carrier frequency that is modulated with the audio signal. All of the carrier frequencies are summed and sent to all other stations by wire. The desired audio signal can be filtered out of the frequency mix by selecting the corresponding carrier frequency in the receiver and demodulating.

Further, reference is had to the following documents as recommended prior art: DE 199 06 381 A1, DE 25 23 864 A1, US 2004/0012669 A1, US 2003/0233416 A1, US 2003/0142635 A1, US 2003/0058806 A1, U.S. Pat. No. 6,654,455 B1, and ITU-T H.323 (July 2003).

Up to the present time, digital systems have taken a proprietary approach. They have in common only that the digital audio data are sent over the line by the time-multiplexing method. This means that a serial data stream is generated in the transmitter in the form of a continuous data frame containing the digital sample values of all of the audio channels. The receiver extracts the sample values associated with the selected channel from the data stream. The synchronization is carried out by means of special data words which identify the start of a data frame at regular intervals. Digital audio data must be transmitted synchronously. To ensure a continuous transmission, the clock rate must be transmitted. For this purpose, methods are employed for recovering the clock from the serial data stream. The advantage of the digital method consists in that a high audio quality can be achieved because the quality of the audio signals is not dependent upon the quality of the transmission path. Error correction methods can be used to reduce interference, and it is possible to ensure privacy by encryption methods. However, the exact form of such digital systems with respect to the number of channels, word length and sampling rate of the digital audio data, and use of error correction methods and encryption methods is not standardized and is adapted to the respective requirements of a system. The cost of setting up a system of this kind is considerable, since all of the components from cables, line drivers and signal processing circuits to application software must be developed anew each time.

### OBJECT AND SUMMARY OF THE INVENTION

Therefore, it is the primary object of the present invention to provide a conference delegate unit (or voice station) and a conference system which can be used universally and which also provide adequate audio quality.

This object is met by a conference delegate unit in accordance with the invention for a conference system comprising an audio unit for converting audio signals with network-specific signals, a network interface for transmitting the network-specific signals to an external network and for receiving network-specific signals from an external network, a network identification unit for storing a network identification and wherein the network interface is a switched Ethernet interface. The object is also met by a conference system in accordance with the invention with a plurality of conference delegate units as described above.

Accordingly, the invention provides a conference delegate unit for a conference system having an audio unit for converting audio signals into network-specific signals, a network interface for transmitting the network-specific signals to an external network and for receiving network-specific signals from an external network, and a network identification unit for storing a network identification.

According to a development of the invention, the network identification stored in the network identification unit is an Internet protocol address.

According to another development of the invention, the audio unit is designed to pick up and reproduce audio signals.

According to another development of the invention, the conference voice station has operator controls for controlling the conference voice station.

The invention is based on the idea of coupling voice stations using a standard network and transmitting the audio data, which is in digitized form, over this network. The advantages of digital audio transmission (high audio quality, protection against interference, integratability of hardware) are combined with the advantages of network transmission (nonproprietary components such as switches, available technology, available protocols). Special methods ensure the continuity of the transmission of the digital audio data to a network which is not designed for synchronous data transmission.

Accordingly, the system comprises a plurality of audio stations which have network connections and which are interconnected using standard components. Every audio station preferably has a microphone and a loudspeaker for picking up and reproducing the audio information. The analog microphone signal is converted into a digital signal or the digital loudspeaker signal is converted into an analog signal, and data information is generated which is compatible with the network standard employed. Generally, microcontrollers having a suitable network interface and corresponding software functions are used. But it is also possible to use programmable logic components (FPGA) or to use standard microcontrollers to which commercially available interface circuits are connected. It is possible to modify the audio stations described herein in such a way that an audio station either has only a microphone or only a loudspeaker. An audio station can be expanded to include display elements (LEDs, LCDs) and function buttons.

The connection of the audio stations is carried out by means of commercially available standard components such as switches and/or routers. Since a plurality of audio stations are connected to each switch or router depending on construction, star cabling of the system is provided.

By using a standard network, additional network-compatible components can be integrated into the system. These components are, first of all, PCs which can realize the control functions in the system or can exchange data with one another independent from the audio functionality of the system. Further, it is conceivable to integrate additional components into the network such as light control systems, media control devices and projectors.

The invention will be described more fully in the following with reference to the drawings.

### BRIEF DESCRIPTION OF THE DRAWINGS

In the drawings:

FIG. 1 shows a conference system according to a first embodiment example;

FIG. 2 shows a conference system according to second embodiment example;

FIG. 3 shows a detail of the audio stations according to the second embodiment example; and

FIG. 4 shows a schematic view of an audio station according to the second embodiment example.

### DESCRIPTION OF THE PREFERRED EMBODIMENTS

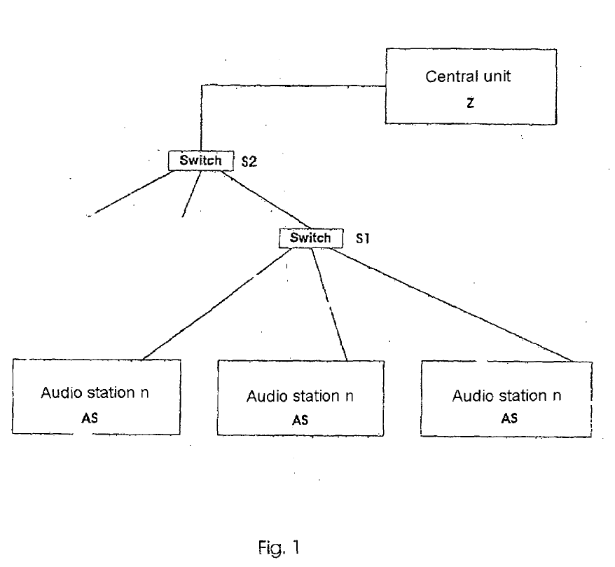

FIG. 1 shows a schematic view of a system according to a first embodiment example of the invention. Three audio stations AS are connected to a first switch S1. This switch S1 is in turn connected to a central unit Z by a second switch S2.

Owing to the spatial positioning of the audio stations, considerable costs can arise from cabling because of the star topology of the network. FIG. 1 shows a system with star-connected audio stations and other components.

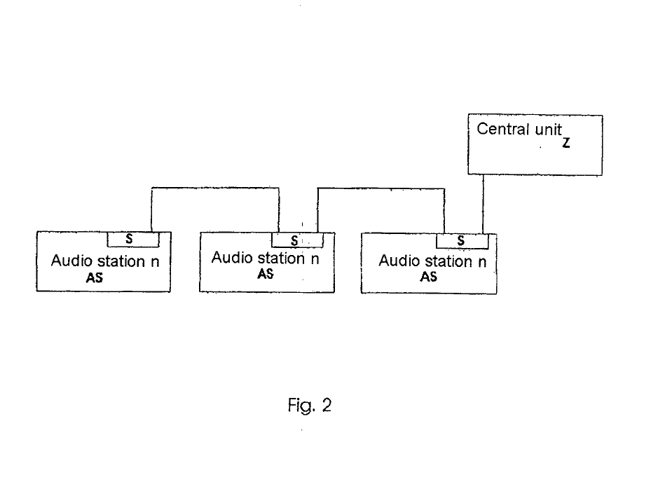

FIG. 2 shows a system according to a second embodiment example. While the system according to the first embodiment example is formed of star-connected audio stations, the system according to the second embodiment example is formed by coupling audio stations AS in a series connection. Standard switches S are integrated in the audio stations for this purpose. Thus, the originally star-shaped topology is changed to a serial configuration. Accordingly, every audio station AS has an integrated network switch S. Every audio station AS that is modified in this way has two or more network connections so that it is possible for the audio stations AS according to FIG. 2 to be connected to one another, one of the audio stations being connected to the central unit Z

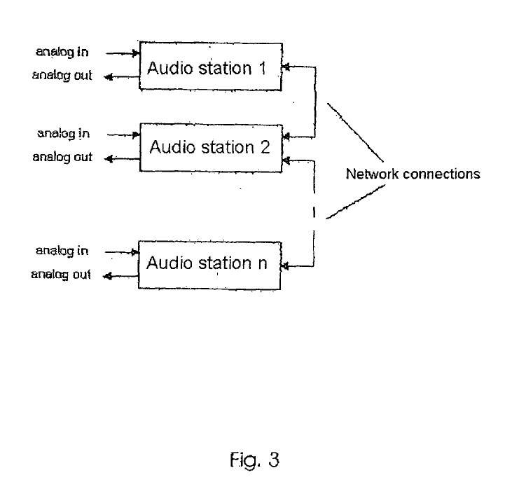

FIG. 3 shows a detailed view of the connection of the audio stations according to the second embodiment example in FIG. 2. Every audio station AS has an analog input a_in to which a microphone, for example, can be connected and can have an analog output a_out for connecting an audio amplifier or a loudspeaker or headphones. This system can be used to build discussion systems or conference systems, for example. The audio stations then serve as conference voice stations but are also suitable generally for applications in which different audio signals are to be transferred over a network. The connection of the audio stations with one another is realized by means of an Ethernet connection. A category 5 twisted pair cable, for example, can be used as physical medium.

Since a collision-free network can best meet the performance requirements with respect to time in transmitting real-time data, a switched Ethernet network with bidirectional connections is preferably used. The special feature of this system consists in that an Ethernet switch is integrated in each audio station AS and therefore standard network technology designed for star topologies can be used for the successive connection of the audio stations.

The switch functionality can also be simulated by using a microcontroller with two integrated Ethernet interfaces and the software of the controller takes over the addressing functions of the switch.

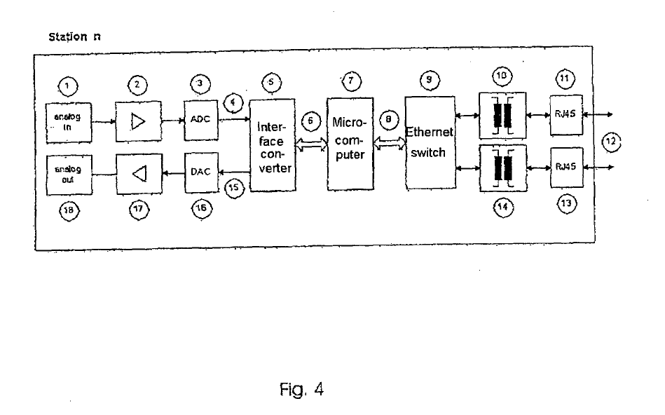

FIG. 4 shows a detail of the construction of an audio station AS according to FIGS. 2 and 3. Every audio station AS has a transmitting unit and a receiving unit. The transmitting unit designates the function blocks for feeding data into the network, the receiving unit designates the function blocks for receiving data from the network. An interface converter 5, a microcontroller 7 and Ethernet switches 9 are used bidirectionally.

Analog data are fed to the audio station AS over the analog input 1. The amplified analog audio signal reaches the analog-to-digital converter 3 via an amplifier 2 which can be constructed in such a way that it can be regulated. A limiter in the amplifier 2 prevents overloading of the analog-to-digital converter input. The A/D converter can have a resolution of 20 bits, for example. The converter generates a digital data stream 4 from the analog audio signal and this digital data stream 4 is fed to an interface converter 5. The interface converter 5 converts the audio sample values contained in the serial data stream into a data format which is suitable for transmitting over an Ethernet network. The audio sample values are conveyed to the microcontroller 7 over a parallel interface 6. The microcontroller 7 loads the data words into a buffer memory and forms a data block from a quantity of data words that are determined beforehand, this data block being embedded in an Ethernet frame according to IEEE 802.3. The Ethernet frame is sent to the port of a 3-port switch 9 via an interface 8 which can conform, e.g., to the MII standard. The RJ-45 connector 11 is connected to the two other ports, respectively, by a transformer 10 so as to produce the physical connection to the network 12. An Internet Protocol address is assigned to every audio station AS, e.g., by a central computer in the network. Alternatively, every audio station can have a fixed IP address.

The Ethernet frames coming from or received from the network pass through the RJ-45 connector 13 and a transformer 14 to the switch 9. It is decided in switch 9 based on the target address or IP address contained in the Ethernet frame whether or not the frame is intended for this audio station AS. If not, the frame is fed back into the network again by the transformer 10 and the connection 11. Otherwise, the frame goes to the microcontroller 7 via the interface 8. The microcontroller removes the data words from the frame and sends them via the parallel interface 6 to the interface converter 5. The interface converter generates a serial data stream 15 from the data words, which serial data stream 15 is converted to an analog audio signal in the digital-to-analog converter 16. The analog audio signal is amplified 17 and supplied to the analog output 18.

A switched Ethernet network with bidirectional connections is preferably used. UDP, for example, can be used as a transmission protocol for the network connection. The audio stations AS send data to all the rest of the audio stations using the broadcast address and a port address or using multicast addresses. The analog signal is converted into digital sample values in the A/D converter. The special feature in this case consists in that using the interface converter makes it possible to use any A/D converter intended for audio use with different sampling rates and resolutions.

The interface converter acts in the audio station as a clock generator. It stores the digital sample values coming from the A/D converter and transmits them at regular intervals to the microcontroller. The interface converter can determine the number of most significant bits of the sample values used for sending over the network. Therefore, the maximum possible number of audio channels can be set depending on the required audio quality of the transmission system. Transmitting this information together with the audio data to the receiver station makes it possible for the receivers to automatically adapt to the setting carried out on the transmission side.

The transmission behavior of the system with respect to time depends on the size of the data packets that are sent over the network. The use of the interface converter with buffer storage of the data makes it possible to set any size of data packets and therefore to optimize the transmission behavior with respect to time.

The system is capable of sending audio data to a plurality of audio stations simultaneously. For this purpose, broadcast addresses, for example, are used for sending data so that the data packets can be received by all of the other connected stations. Different port numbers known to each receiver are given to distinguish between different audio channels. Another possibility is to use multicast addresses which are different for every audio channel to be transmitted. The choice of which channel should be received by which audio station is made in the receiver by logging on to one of the multicast groups.

The audio station can be outfitted with two or more Ethernet interfaces in a simple manner through the use of a switch. This makes it possible to connect stations by short connection cables and, when there are more than two interfaces, to connect additional devices such as computers with Ethernet interfaces to the audio station.

In order to receive audio data, the port to be assigned to the received audio channel is selected in the microcontroller. The audio data are transmitted from the microcontroller to the interface converter at regular time intervals which are predetermined by the interface converter. Since the clock generators in the received audio stations are not synchronized with the clock generator in the transmitting audio station, functions are implemented in the receivers to compensate for any existing frequency differences in the audio stations.

Based on the information made available by the transmitting audio station, the interface converter is capable of setting the size of the buffer memory and forwarding the audio sample values with the correct resolution to the D/A converter.

According to a third embodiment example of the invention, based on the second embodiment example, a system of coupled audio stations can be used as an audio conference system. The audio stations are constructed as conference voice stations and have a microphone and can have a loudspeaker for picking up and reproducing the audio information. Alternatively, or in addition, a connection can also be provided for headphones or headsets. The power supply of the audio stations can be constructed, for example, as a remote feed over the network connection. Since the network conveys not only audio information but also any data, far-reaching additional functions are possible in an audio station.

The audio stations can be outfitted with function buttons which can be used for a variety of signaling tasks in the network. For example, permission to speak can be requested in the central control of the conference system from every voice station. The microphone would then be switched on by the control in the event that a transmission channel is free.

Operating states of the voice station and messages sent within the network can be displayed by means of display elements which are installed in the conference voice stations and which can be constructed as LEDs, character LCDs or dot matrix LCDs. The voice stations can be outfitted with a chip card reader which makes it possible for the station to be used only by those persons having a correspondingly programmed chip card. Information on the chip card can be evaluated locally in the voice station and also sent over the network to a central control. This form of access authorization could be applied, for example, in the voting system which will be described further on and which can likewise be realized by means of the audio stations.

The audio stations have one or more analog inputs to which, for example, external signal sources can be connected for piping in speech or music. Further, one or more analog outputs are provided for connecting headphones or analog transducer devices.

An additional network connection to the audio station permits a direct data connection between a laptop and the station. This additional network connection can be constructed as an Ethernet interface, a WLAN interface and/or a Bluetooth interface.

Three different constructions of conference delegate units or voice stations can be provided in the conference system. The first construction of the voice station is a delegate voice station by means of which a delegate can follow a conference and, if required, can speak to other participants in the conference by actuating the on/off switch for the microphone in the voice station. Another voice station is a voice station for interpreters for simultaneous translation of the contributions of the delegates into the desired languages. The simultaneously translated contributions of the delegates can be accessed by all of the delegates or an available language can be determined beforehand by personalization. The conference system can be substantially controlled by means of a chairman or moderator voice station. For example, a delegate whose contribution has extended beyond the allotted time can be interrupted by stopping or interrupting the transmission of the audio signals. Alternatively, the chairman voice station can be designed to switch to the voice station assigned to the next speaker. Further, the chainman voice station can be suitable for preventing direct communication between two delegates.

The voice stations can be constructed either as delegate voice stations, chairman voice stations or interpreter voice stations. A chairman voice station has additional functions by means of which the progress of a conference can be controlled. For example, certain function buttons can turn on or turn off the microphones of other audio stations. An interpreter voice station has certain functions which permit listening to one audio channel while simultaneously speaking on another audio channel.

It is also possible to outfit the voice stations with a voting function. Again, this makes use of function buttons allocated to the corresponding voting possibilities, for example, “Yes”, “No”, “Abstain”. The information about which button was pressed at the audio station is sent over the network to the central control and the voting results are determined and displayed.

The use of a standard network makes it possible to couple conferences to the Internet. Participants outside of the conference room can log on to a conference using suitable hardware components by Internet and Voice-over IP. Also, it is possible to connect wireless audio stations or other network-compatible components into the conference system by means of WLAN components.

Since the coupling of the voice stations is realized by means of standard network technology, an audio conference system constructed in this way can be connected to a total media system. This contains, for example, loudspeakers or a complete sound system which makes the audio signal of the conference system available to a larger audience. Further, it is possible to connect an external interpreter system or infrared interpreter system. Audio stations without a microphone or loudspeaker but with an integrated H.F. receiver stage serve to operate wireless microphones. In a total media system, the presentation technique can be controlled over the same network using network-compatible beamers and projection screens. Existing media controls can be used to control the audio conference system within a total system of this description so that there is no need for a special control system that is adapted only to the audio conference system.

The use of standard network technology opens up novel features. For example, by connecting the laptop of a conference participant, presentations can be made from the participant's location. Further, it is possible for conference participants to exchange data between one another. The conference participant can be reached by e-mail and has access to the Internet during the conference.

It is possible to couple segments wirelessly by WLAN. This concerns locations, for example, that cannot be reached by cable or, if so, only at great cost. Different rooms or buildings can be connected in this way. For laptops, PDAs, etc. it is possible to access the system wirelessly. The devices can also be connected as voice stations using suitable software.

According to another embodiment example of the invention, the network for the conference system is based on a wireless local area network WLAN. A wireless local area network WLAN designates a wireless local network based on the IEEE standard 802.11 family. WLAN networks usually operate in an infrastructure mode in which one or more base stations, i.e., wireless access points, control communication between the clients in the network. The transfer of data is generally carried out via different access points. An alternative possibility consists in an ad hoc network in which the clients communicate directly with one another. An ad hoc network of this kind is a wireless architecture which is formed between two or more mobile end users without a fixed infrastructure.

Each client, i.e., each conference voice station, is assigned an Internet protocol IP address, for example, by a central computer in the WLAN network. An IP address allows a logical addressing of computers or network elements in IP networks such as the Internet. These IP addresses are entered in the source and target address fields in every IP packet, i.e., every IP packet contains information about the address of the sender and receiver. Version 4 of the Internet Protocol IPv4 allows, for example, the use of IP addresses with 32 bits which are separated by four dots. Every 32-bit IP address is divided into a network part and a device part (host part). In the simplest case, the first 16 bits represent the network part and the last 16 bits represent the device part. The sixth version of the IP Protocol is based on the use of 128-bit addresses. The IP addresses can be permanently assigned to a network element or can be assigned dynamically by a corresponding dial-up. Within private networks, the IP address itself can be assigned. A connection of all computers with correspondingly assigned IP addresses in a private network with computers in the Internet is carried out by a Network Address Translation NAT.

IP addresses can be assigned by a corresponding network server by means of protocols such as BOTP or DHCP when network elements log on to a network. In this case, a range of IP addresses can be defined on the network server and additional network elements can be assigned a corresponding IP address from this range of IP addresses. However, an address of this kind is not a fixed IP address and is only valid for the period during which the network element is logged on to the network. In case the network element requires a fixed IP address, the network elements can be identified, for example, by their MAC (Media Access Control) address and can obtain a permanent IP address.

While the foregoing description and drawings represent the present invention, it will be obvious to those skilled in the art that various changes may be made therein without departing from the true spirit and scope of the present invention.

What is claimed is:

1-12. (canceled)

13. A conference delegate unit for a conference system comprising:
an audio unit for converting audio signals into network-specific signals, a network interface for transmitting the network-specific signals to an external network and for receiving network-specific signals from an external network;
a network identification unit for storing a network identification; and
said network interface being a switched Ethernet interface.

14. The conference delegate unit according to claim 13, wherein the network identification stored in the network identification unit is an Internet protocol address.

15. The conference delegate unit according to claim 13, wherein the audio unit is constructed for picking up and reproducing audio signals.

16. The conference delegate unit according to claim 13, further having operator controls for controlling the conference delegate unit.

17. The conference delegate unit according to claim 13, wherein the switched Ethernet interface is suitable for connecting a plurality of conference delegate units.

18. The conference delegate unit according to claim 13, further with a second network interface for communicating with external network interfaces.

19. A conference delegate unit for a conference system comprising:
an audio unit for converting, audio signals into network-specific signals;
a network interface for transmitting the network-specific signals to an external network and for receiving network-specific signals from an external network;
a network identification unit for storing a network identification; and
said network interface being constructed as a WLAN interface or as a WLAN interface or as a Bluetooth interface.

20. The conference delegate unit according to claim 19, wherein the network identification stored in the network identification unit is an Internet protocol address.

21. The conference delegate unit according to claim 19, wherein the audio unit is constructed for picking up and reproducing audio signals.

22. The conference delegate unit according to claim 19, further having operator controls for controlling the conference delegate unit.

23. The conference system with a plurality of conference delegate units according to claim 13.

24. The conference system according to claim 23, further with a central unit for controlling the plurality of conference delegate units.
